(19) United States
(12) Patent Application Publication
(10) Pub. No.: US 2015/0214607 A1
(43) Pub. Date: Jul. 30, 2015

(54) MULTIPLE BAND ANTENNA FOR VEHICLE AND MANUFACTURING METHOD THEREOF

(71) Applicants: Hyundai Motor Company, Seoul (KR); INFAC Elecs Co., Ltd, Suwon (KR)

(72) Inventors: Sang Heun Lee, Seoul (KR); Heui Tae Lee, Suwon (KR); Ho Young Cho, Hwaseong (KR); Min Kyung Jang, Incheon (KR); Kang Young Lee, Incheon (KR); Sang Hoon Lim, Ansan (KR); Jin Kyu Hwang, Incheon (KR); Soo Young Hwang, Bucheon (KR); Un Young Jeong, Suwon (KR)

(21) Appl. No.: 14/571,720

(22) Filed: Dec. 16, 2014

(30) Foreign Application Priority Data
Jan. 28, 2014 (KR) 10-2013-0010170

(51) Int. Cl. H01Q 1/32; H01Q 5/307; H01P 11/00; H01Q 1/36

(52) U.S. Cl. CPC H01Q 1/3275; H01Q 1/362; H01Q 5/307; H01P 11/001

(57) ABSTRACT

The present disclosure provides a multiple band antenna for a vehicle able to receive multiple signals in various frequency bands, including radio, TV, mobile communication, GPS, telematics, and so forth, through one antenna. The multiple band antenna for a vehicle includes an elongated pole that is coupled to a base, the pole including: a connector having a connecting portion connected to a terminal of the base, a signal coil having one end portion connected to the connector and having a spirally wound helical portion, a bobbin fitted around the signal coil such that the signal coil is inserted therein, a coil member formed in the shape of a spirally wound coil and fitted around the bobbin, with one end portion connected to the connector; and a cover member covering the bobbin and the coil member.

### CROSS-REFERENCE TO RELATED APPLICATION

This application claims under 35 U.S.C. §119(a) priority to and the benefit of Korean Patent Application No. 10-2014-0010170 filed on Jan. 28, 2014, the entire contents of which are incorporated herein by reference.

### BACKGROUND

(a) Technical Field

The present disclosure relates to a multiple band antenna for a vehicle and a manufacturing method thereof. More particularly, the present disclosure relates to a multiple band antenna for a vehicle which can minimize the manufacturing cost due to additional telematics antennas, such as High-Speed Downlink Packet Access (HSDPA) antennas, and receive multiple signals for wireless communication services in various bands, such as GPS, GSM, CDMA, HSDPA, LTE, e-Call, DMB, and DAB, as well as a method of manufacturing the aforementioned multiple band antenna.

(b) Background Art

Automotive antennas transmit/receive wireless signals to enable a transceiver for broadcast/communication in vehicles to communicate with the outside. The existing automotive antennas are generally used only for receiving AM/FM radio signals, and monopole types of passive antennas without an amplifying circuit are commonly used. Those automotive antennas, however, require an excessive physical length, e.g., about 70 cm, such that they spoil the external design and reduce the driving performance of vehicles.

Accordingly, active antennas with an amplifying circuit have been developed to reduce the physical length and poor reception of signals, most of them being pole-type helical antennas. The pole-type helical antenna, an antenna with a spiral coil-shaped structure capable of generating resonance at a length smaller than the existing resonant lengths, can receive broadcast signals by generating resonance at a specific frequency, by adjusting the length and the pitch. On the other hand, recently, with the common use of services such as mobile communication, various pieces of equipment and new electronic products with information communication technology have been developed in succession. Further, electronic products featuring technology integrating the internet, a television, global positioning system (GPS), a satellite radio, Digital Multimedia Broadcasting (DMB), and telematics have been developed and mounted in vehicles in order to satisfy various requirements of consumers.

As wireless services in vehicles, e.g., the internet, TV, GPS, satellite radio, DMB, telematics, etc., increases, it is increasingly important to utilize an antenna capable of receiving various wireless signals, particularly an integrated antenna providing a wireless communication service in various bands. To this end, an integrated antenna of the related art is described hereafter with reference to the accompanying drawings.

FIG. 1A is a perspective view illustrating an integrated antenna of the related art, and FIG. 1B is a perspective view illustrating the integrated antenna of FIG. 1A with the case for the base removed, in which the integrated antenna has no antenna (HSDPA, etc.) for telematics. As illustrated in FIGS. 1A and 1B, the integrated antenna largely includes a base 1 with built-in components including a pad 2a, a frame 2b, a case 4, a circuit board 3a, and a patch antenna 3b (satellite radio patch antenna or other patch antenna), and a pole 5 with a built-in radio antenna. The integrated antenna without a telematics antenna has a better design and commercial value in comparison with the integrated antennas with a telematics antenna, because the case 4 for the base 1 is flat.

FIG. 2A is a perspective view illustrating an integrated antenna with a telematics antenna of the related art, and FIG. 2B is a perspective view illustrating the integrated antenna of FIG. 2A with the case for the base removed. As illustrated in FIGS. 2A and 2B, a GPS antenna 3d and a telematics (TMU: Telematics Unit) antenna 3c for receiving signals are disposed in the base 1, and a pole 5 with a built-in radio antenna is disposed on one side of the base. In the integrated antenna shown in FIGS. 2A and 2B, the case 4 requires a greater height to fit the telematics antenna 3c (HSDPA or other TMU antenna) disposed vertically high, for sufficient reception ability, and thus it is difficult to achieve an entirely flat base.

Problematically, the integrated antenna with the case 4 having a greater height has an adverse influence on the entire design of vehicles and can reduce the commercial value of vehicles. Further, when antennas (receivers) are close to each other, there is a need for an appropriate distance between them because they may influence each other. However, when telematics (e.g., HSDPA and other TMU antennas) is added, the performance of antennas for other services can be deteriorated, or an additional space for a telematics antenna can be required.

### RELATED ART DOCUMENT

### Patent Document

(Patent Document 1) Korean Patent No. 10-1161207 (Jun. 25, 2012)

(Patent Document 2) Korean Patent Application Laid-Open No. 10-2013-0037891 (Apr. 17, 2013)

The above information disclosed in this Background section is only for enhancement of understanding of the background of the disclosure, and therefore it may contain information that does not form the related art that is already known in this country to a person of ordinary skill in the art.

### SUMMARY OF THE DISCLOSURE

The disclosed embodiments been made in an effort to solve the above-described problems associated with related art. An object of the present disclosure is to provide a multiple band antenna for a vehicle which can receive signals in radio frequency bands (AM/FM), broadcast bands (DMB, DAB), mobile communication frequency bands (GPS, GSM, CDMA, WCDMA, HSDPA, LTE) and signals for wireless communication services such as satellite radio (SDARS), the internet, TV reception, navigation system (GPS), using one antenna by installing a helical type signal coil that can implement a TMU (GSM, CDMA, WCDMA, HSDPA, LTE, e-Call, and the like.) and a DMB therein, in addition to a coil member receiving frequency signals in the radio band, and a method of manufacturing the multiple band antenna. Further, another object of the present disclosure is to provide a multiple band antenna for a vehicle having excellent design and performance, thus reducing the manufacturing costs and costs due to a TMU antenna, as much as possible.

In particular, the antennas of the related art can be classified as an integrated antenna without telematics (e.g., having a flat case) or an integrated antenna with telematics (e.g., having with case with greater height), as shown in FIGS. 1 and 2. However, another object of the present disclosure is to provide an integrated antenna capable of implementing an integrated antenna with telematics in the shape of the integrated antenna without telematics of the related art, and a method of manufacturing the integrated antenna.

In one aspect, the present disclosure provides a multiple band antenna for a vehicle including an elongated pole that is coupled to a base, in which the pole includes: a connector having a connecting portion connected to a terminal of the base; a signal coil having one end portion connected to the connector and having a spirally wound helical portion; a bobbin fitted around the signal coil such that the signal coil is inserted therein; a coil member formed in the shape of a spirally wound coil and fitted around the bobbin, with one end portion connected to the connector; and a cover member covering the bobbin and the coil member.

In another aspect, the present disclosure provides a method of manufacturing a multiple band antenna for a vehicle including an elongated pole that is coupled to a base. For manufacturing the pole, the method includes: manufacturing a signal coil and a connector with a connecting portion connected to a terminal of the base and manufacturing a bobbin and a coil member formed in the shape of a spirally wound coil; connecting one end portion of the signal coil to the connector; fitting the coil member around the bobbin; forming an intermediate assembly by fitting the bobbin around the signal coil such that the signal coil is inserted therein and by connecting one end portion of the coil member to the connector; and fixing the intermediate assembly in a mold and injection-molding a cover member to cover the coil member and the bobbin.

Accordingly, since the antenna of the present disclosure can receive multiple signals in various frequency bands, including radio, TV, mobile communication, GPS, telematics, and so forth, through one antenna, it is possible to optimize the product, reduce the manufacturing cost, and improve the design.

Other aspects and preferred embodiments of the present disclosure are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1A is a perspective view illustrating an integrated antenna according to the related art;

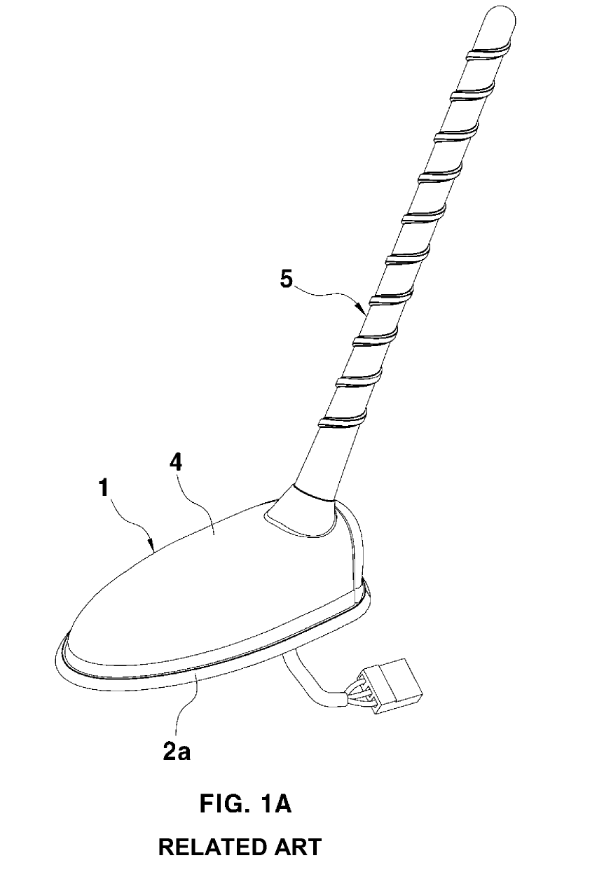

FIG. 1B is a perspective view illustrating the integrated antenna of FIG. 1A with the case for the base removed;

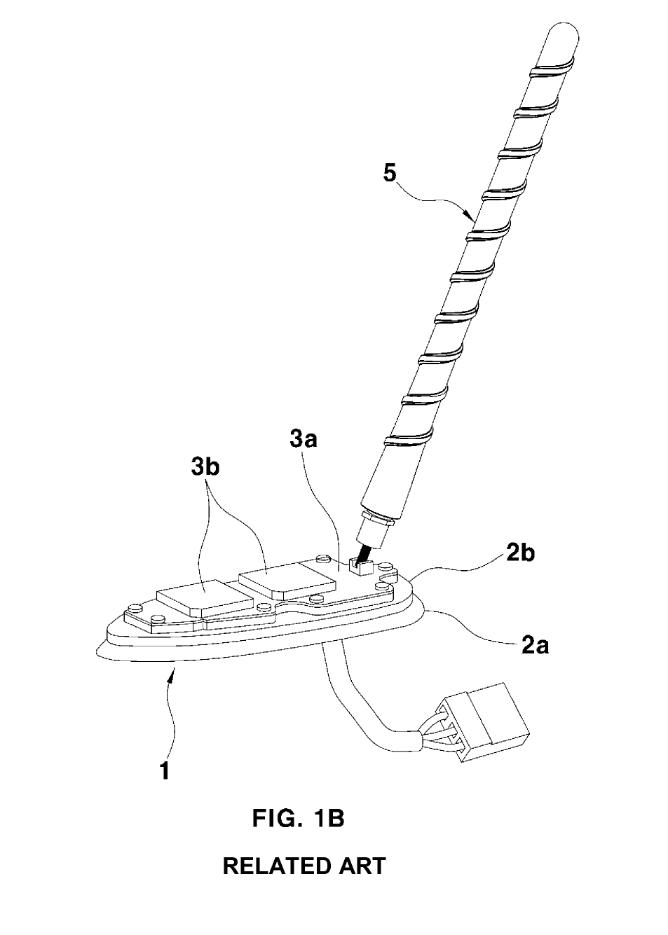

FIG. 2A is a perspective view illustrating another integrated antenna according to the related art;

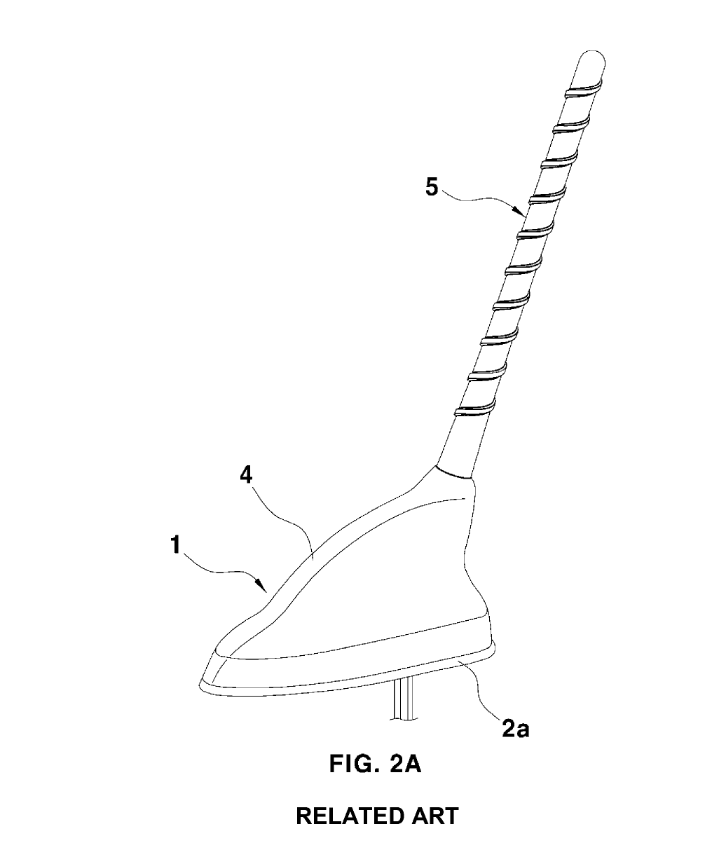

FIG. 2B is a perspective view illustrating the integrated antenna of FIG. 2A with the case for the base removed;

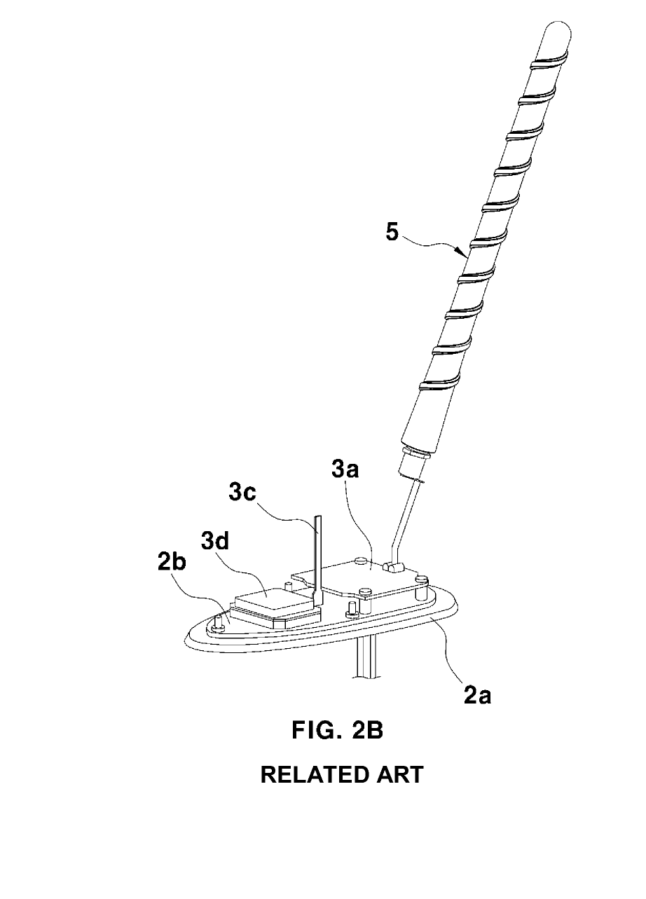

FIG. 3 is a cross-sectional view of a multiple band antenna for a vehicle according to an embodiment of the present disclosure;

FIG. 4 is a longitudinal cross-sectional view of the pole of the multiple band antenna for a vehicle according to an embodiment of the present disclosure;

FIG. 5 is an exploded view of the pole of the multiple band antenna for a vehicle according to an embodiment of the present disclosure;

FIG. 6 is a view illustrating that various examples of signal coils which can be used for the multiple band antenna for a vehicle according to an embodiment of the present disclosure are fixed to connectors;

FIG. 7 is a view illustrating only the signal coil in the multiple band antenna for a vehicle according to an embodiment of the present disclosure;

FIG. 8 is a view illustrating an example of thread-fastening a signal coil to a connector in the multiple band antenna for a vehicle according to an embodiment of the present disclosure;

FIG. 9 is a view sequentially illustrating the process of manufacturing the pole of the multiple band antenna for a vehicle according to an embodiment of the present disclosure;

FIG. 10 is a view illustrating a mold and a pin for forming a bobbin in the present disclosure;

FIG. 11 is a view illustrating a mold and a support pin for forming a fixing member in the present disclosure;

FIG. 12 is a view illustrating a mold for forming a cover member in the present disclosure; and

FIG. 13 is a view illustrating an external core and a molding pin of a fixing unit in forming of the cover member in the present disclosure.

Reference numerals set forth in the Drawings includes reference to the following elements as further discussed below:

| | |
|---|---|
| 100: antenna | 110: base |
| 120: pole | 121: connector |
| 122: signal coil | 122b: helical portion |
| 123: bobbin | 124: coil member |
| 125: cover member | 126: fixing member |
| 127: end cap | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the disclosed embodiments throughout.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, exemplary embodiments of the present disclosure will be described more fully with reference to the accompanying drawings for those skilled in the art to easily implement the disclosed embodiments. The present disclosure provides an integrated antenna (e.g., antenna with telematics) that makes it possible to reduce the manufacturing cost resulting from the addition of telematics, having the external shape of an antenna with telematics, and that can sufficiently perform the function of receiving telematics. The integrated antenna of the present disclosure can receive signals such as GSM, CDMA, WCDMA, HSDPA, LTE, and e-Call signals, and signals for broadcasting such as DMB and DAB, in addition to radio signals (AM/FM) through a pole.

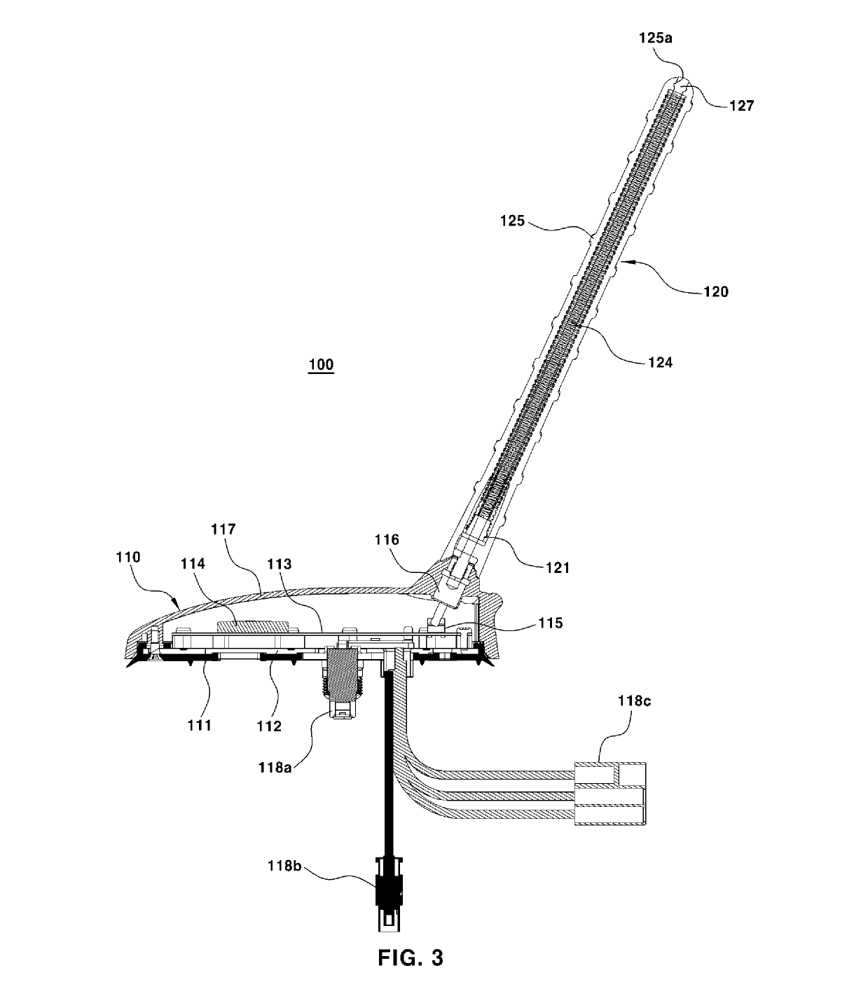

FIG. 3 is a cross-sectional view of a multiple band antenna for a vehicle according to an embodiment of the present disclosure. As illustrated in FIG. 3, the multiple band antenna 100 according to an embodiment of the present disclosure includes a base 110, which is composed of built-in components including a pad 111, a frame 112, a case 117, a circuit board 113, an antenna 114 for receiving signals in multiple bands including, for example, GPS, XM, SIRIUS, and the like, a connector 116, a terminal 115, and a pole 120 elongated from the base 110, and further including an antenna coil (composed of a signal coil and a coil member to be described below). Not only is the circuit board 113 fixed to the frame 112, but the antenna 114 is disposed in the base 110, and the lower part of the pad 111, which is attached to a vehicle body (e.g., outer side of a roof panel), is integrally attached to the frame 112. The base 110 has the connector 116 (female or male connector) to which the connector 121 (male or female connector) of the pole 120, which is described below, can be mated. The case 117, which contributes to the external appearance of the multiple band antenna, is fastened to the frame 112, covering the built-in components such as the circuit board 113, the antenna 114, the connector 116, and the terminal 115. The reference numerals 118a, 118b, and 118c shown in FIG. 3 indicate coupling members that transmit received signals to the outside. The coupling members 118a, 118b, and 118c are electrically connected to the circuit board 113 in the base 110 to transmit received signal to the outside.

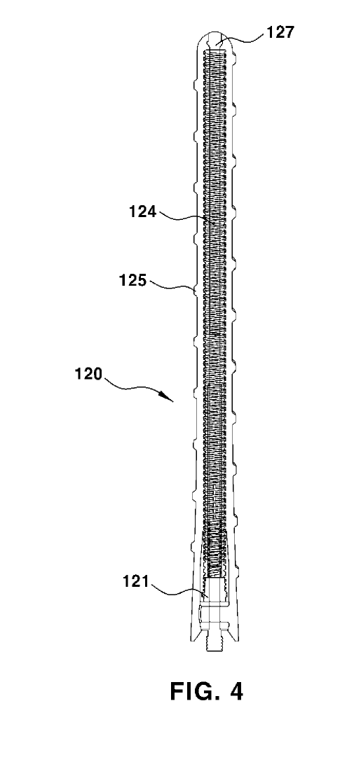

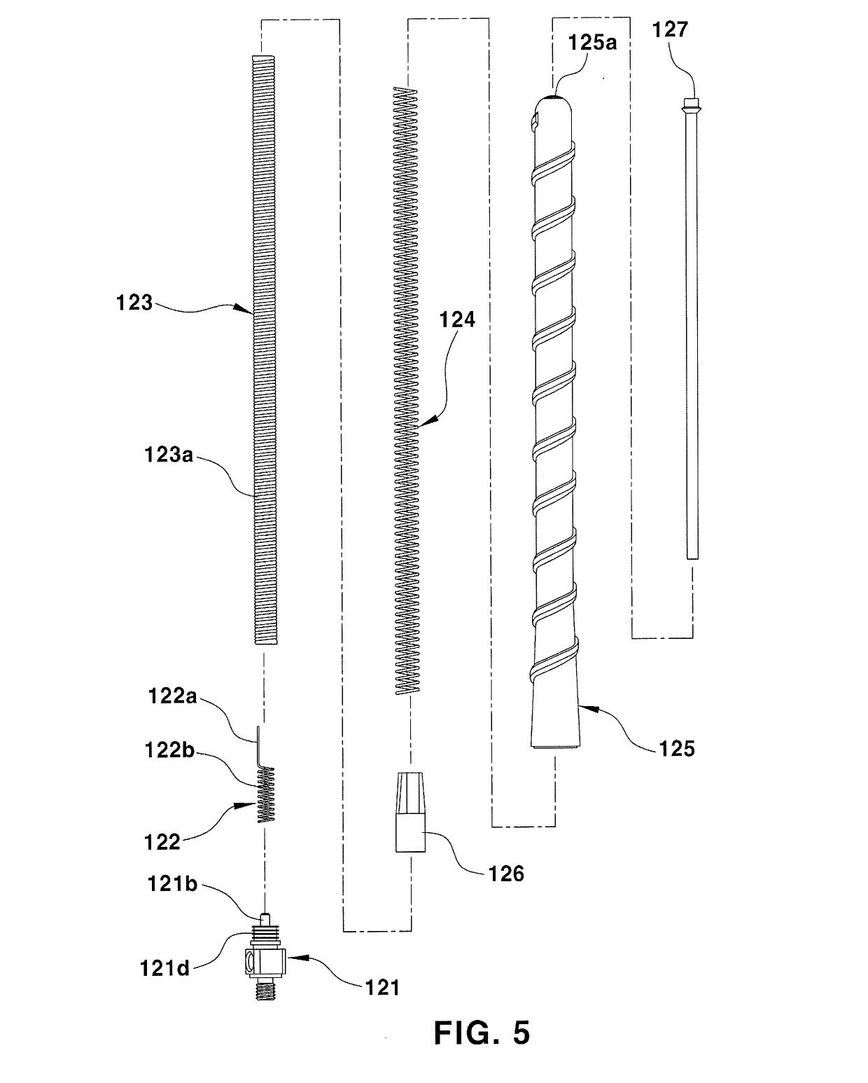

FIG. 4 is a longitudinal cross-sectional view of the pole of the multiple band antenna for a vehicle according to an embodiment of the present disclosure, and FIG. 5 is an exploded view of the pole of the multiple band antenna for a vehicle according to an embodiment of the present disclosure. As illustrated in FIGS. 4 and 5, the pole 120 includes a connector 121, a signal coil 122, a bobbin 123, a coil member 124, and a cover member 125.

The connector 121 of the pole 120, which is coupled to the connector 116 of the base 110, is connected to the circuit board 113 in the base 110 through the connector 116 and the terminal 115 of the base 110 (see FIG. 3) and transmits signals received from the signal coil 122 and the coil member 124 to the circuit board 113. The signal coil 122 has a predetermined length with one end connected to the connector 121. The signal coil 122 has at least one helical portion 122b spirally wound with a predetermined length and can be designed such that the number, wiring pitch, length, outer diameter, inner diameter of the helical portion 122b and the diameter of the coil (e.g., wire diameter) are adjusted in various ways, such that the signal coil 122 can selectively receive signals in various frequency bands such as GSM 850, GSM 1900, CDMA, WCDMA, HSDPA, LTE, e-Call, DAB, and the like, depending on the number, shape, and dimensions of the helical portion 122b.

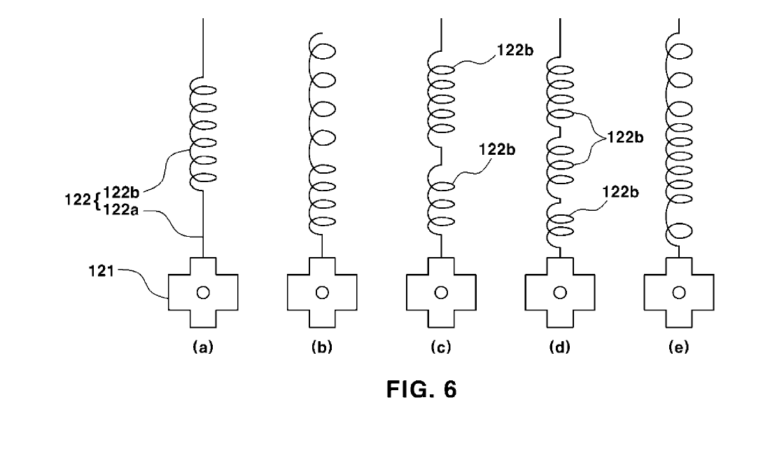

FIG. 6 is a view illustrating various exemplary shapes of the signal coil in an embodiment of the present disclosure. The signal coil 122 where one end of the connector 121 is fixed may be formed in the shape of a straight pin, but in this case, although the operation frequency band can be adjusted by changing the entire length, only single resonance can be achieved. On the other hand, as illustrated in FIG. 6, when the helical portion 122b is formed at the signal coil 122 and the shape of the helical portion 122b is varied, the characteristics such as double resonance (with a single helical portion) or triple resonance (with a double helical portion) can be selectively achieved and the coil generating multiple resonance can simplify the shape of the antenna and reduce the cost. However, the operation frequency band and the antenna matching should be considered when designing the entire shape of the signal coil 122, including the number and shape of the helical portion 122b.

Referring to FIG. 6, several examples of the signal coil 122 with one or a plurality of helical portions 122b or with different wiring pitches for sections are illustrated. In the example illustrated in the figure, it is possible to achieve double resonance with the signal coil 122 with the helical portion 122b having a constant wiring pitch (see (a) of FIG. 6), and it is possible to achieve multiple resonance such as triple resonance with the signal coil 122 with two or more helical portions 122b that are longitudinally arranged (see (c) and (d) of FIG. 6).

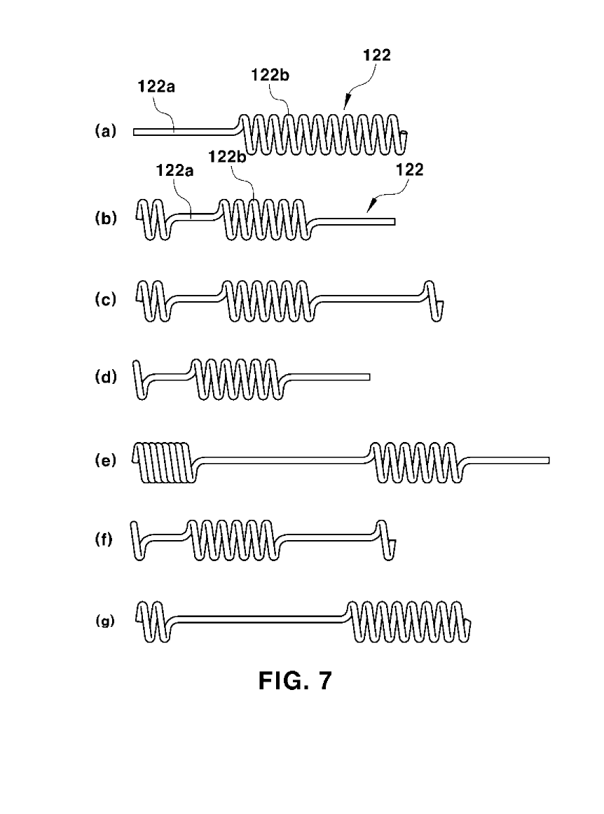

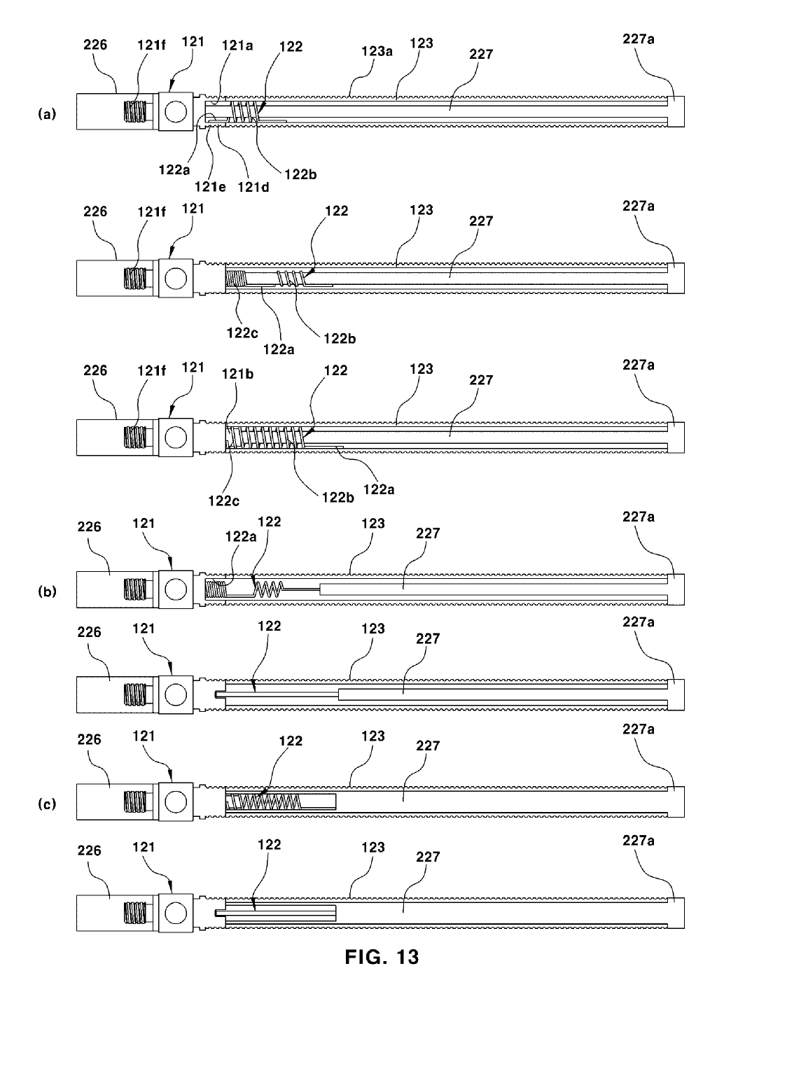

FIG. 7 illustrates only signal coils, in which various shapes of signal coils 122 with straight portions 122a and helical portions 122b longitudinally arranged and appropriately combined are illustrated and the helical portions 122b are formed in various shapes along the longitudinal sections of the signal coils 122. As illustrated in the figure, various numbers of helical portions 122b can be formed at various positions on the signal coils 122, and when a plurality of helical portions 122b is formed, the wiring pitches of the whole helical portions 122b may be the same, the wiring pitches of only some of the whole helical portions 122b may be the same, or the wiring pitches of the whole helical portions 122b may be different. The signal coil 122 may be fixed to be able to be connected to the connector 121. For example, the straight portion (e.g., 122a in (a) of FIG. 6) of one end of the signal coil may be fitted and fixed in the groove formed on the connector 121, one end portion (which may be straight or wound spirally) of the signal coil is inserted in a groove (121a in FIG. 13) of the connector 121 and then welded or bonded to the inner side of the groove, or one end portion (which may be straight or wound) of the signal coil 122 may be welded or bonded to the connector 121 without a groove.

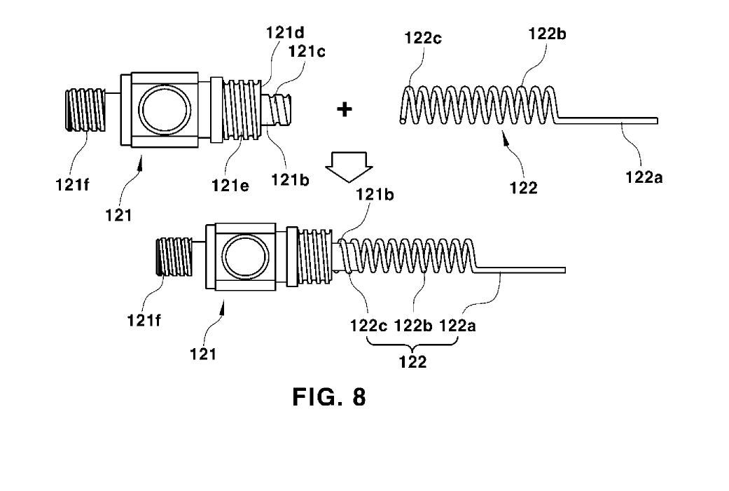

In the welding or bonding of one end to the connector 121 without a groove, the wiring portion (e.g., 122c in FIG. 13) of the signal coil 122 may be welded or bonded to the connector 121 (see e.g., the middle one in (a) of FIG. 13), or one straight end portion of the signal coil 122 may be welded or bonded to the outer side of a first coupling portion. The first coupling portion is indicated by a reference number 121b in FIG. 8, and one end portion of the signal coil 122 may be fixed to the outer side of the first coupling portion 121b without a spiral groove 121c illustrated in the figure. Alternatively, one end portion of the signal coil 122 may be spirally wound, similar to the helical portion 122b, and then the wiring portion (e.g., 122c in FIG. 8) may be thread-fastened to a spiral groove (e.g., 121c in FIG. 8) formed around the outer side of the first coupling portion 121b of the connector 121 (see e.g., FIG. 8). Further, it may be possible to fix the wiring portion 122c of the signal coil 122 by additionally welding or bonding it to the outer side of the connector 121, after thread-fastening the wiring portion 122c of the signal coil 122 to the first coupling portion 121b of the connector 121. The method of fixing the signal coil 122 is not limited, as long as it can connect and fix one end portion of the signal coil 122 to the connector 121.

When there is a need for designing the diameter of the coupling portion (e.g., first coupling portion 121b in FIG. 8) for the signal coil 122 with a relatively small diameter, it is possible to couple one end portion of the signal coil 122 to the outer side of the coupling portion. Conversely, when a coupling portion with a large diameter can be formed, it is possible to form a groove (e.g., 121a in FIG. 13) at the coupling portion of the connector 121 and to couple one end portion of the signal coil 122 to the inside of the groove. The signal coil 122 can be fixed to the connector 121 selectively by appropriate one of the ways described above.

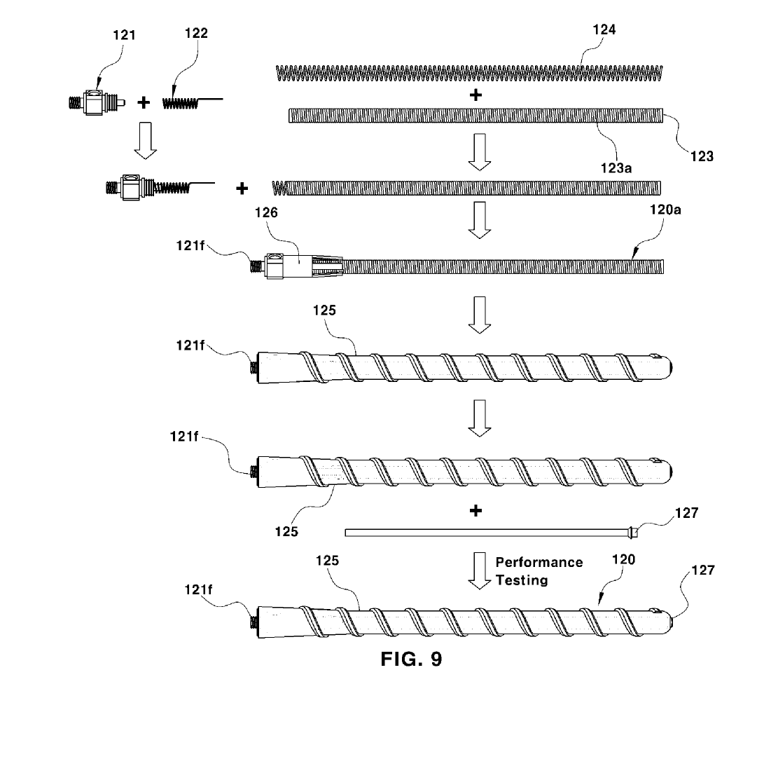

FIG. 8 is a view illustrating an example of thread-fastening the connector 121 and the signal coil 122 in an embodiment. As illustrated in the figure, a spiral groove 121c is formed around the outer side of the first coupling portion 121b of the connector 121 and one end portion (e.g., wiring portion 122c) of the signal coil 122 can be fastened by thread-fastening. The coil member 124, which receives signals in a radio frequency band, is formed in the shape of a spiral coil and is fitted and supported on a hollow bobbin 123. The bobbin 123, a built-in member for supporting the coil member 124 in the pole 120, has a spiral groove 123a around the outer side and the coil member 124 is fitted in the spiral groove 123a by thread-fastening. When the bobbin 123 with the coil member 124 thereon is combined with the connector 121, the signal coil 122 combined with the connector 121 is inserted into one end portion of the hollow bobbin 123, and one end portion of the coil member 124 is coupled to the second coupling portion 121d of the connector 121 (see e.g., FIG. 9).

Thread-fastening may be used to combine the coil member 124 with the connector 121, and to this end, a spiral groove (e.g., 121e in FIG. 8) is formed around the outer side of the second coupling portion (e.g., 121d in FIG. 8) to thread-fasten the coil member 124. Consequently, the second coupling portion 121d having a relatively large diameter is formed at the connector 121, and the first coupling portion 121b having a relatively small diameter is integrally formed at the second coupling portion 121d, such that the signal coil 122 is coupled to the first coupling portion 121b and the coil member 124 is coupled to the second coupling portion 121d. Accordingly, after the coil member 124 is combined with the bobbin 123, when the signal coil 122 fixed to the connector 121 is inserted in the bobbin 123 and one end portion of the coil member 124 is thread-fastened to the second coupling portion 121d of the connector 121, the signal coil 122, bobbin 123, and coil member 124 can be integrally assembled (see e.g., FIG. 9).

After the assembly, it is preferable to cover the coupled portion between the connector 121 and the outside of the one end of coil member 124, that is, the second coupling portion 121d of the connector 121 and the end of the coil member 124 with a fixing member 126 in order to reinforce the coupled portion and stably fix the coil member 124 and the bobbin 123 to the connector 121. The fixing member 126 may be formed by injection molding. For example, the fixing member may be formed by putting the coil member 124 fitted on the bobbin 123 and combined with the connector 121 into a mold and injecting resin to the outside the coupled portion, in which the fixing member 126 is injected to cover the coupled portion, such that the coil member 124 can be stably fixed to the connector 121.

The wiring pitches may be made different for each of the longitudinally predetermined sections, and accordingly, the coil member 124 can also generate multiple resonance levels. For example, it is possible to enable the coil member 124 to receive a double resonance frequency by making the wiring number and the wiring pitch different at the longitudinally upper and lower portions and adjusting the length of the portions.

The cover member 125, which defines the outer cover of the pole 120, that is, the outer shape of the pole 120, covers the other potions except for the connecting portion 121f of the connector 121 and it may also be formed by injection molding. That is, it is possible to form the cover member 125, which is the outer cover, by assembling the connector 121 and the signal coil 122, and the bobbin 123 and the coil member, forming the fixing member 126, putting the assembly into a mold, and then injecting resin. The cover member 125 insulates the coil member 124 and a portion of the connector 121 (except for the connecting portion), protecting the coil member 124, bobbin 123, and connector 121, and it can be finished by forming a hole 125a at the end of the cover member 125 via injection molding, and then inserting an end cap 127 into the hole 125a. The end cap 127, which can be inserted deep inside the bobbin 123 through the hole 125a at the end of the cover member 125, is inserted in the bobbin 123, with one end portion of the end cap 127 closing the hole 125a at the end of the cover member 125. Accordingly, the cover member 125 covers and protects the coil member 124 and the bobbin 123, and the end cap 127 is inserted in the bobbin 123, such that the bobbin 123 and the coil member 124 are supported on the cover member 125 by the end cap 127 too, and that the parts can be stably and integrally assembled.

The manufacturing method of the multiple band antenna according to an embodiment of the present disclosure is described hereafter.

FIG. 9 is a view sequentially illustrating the process of manufacturing the pole 120 of the multiple band antenna for a vehicle according to an embodiment of the present disclosure. First, the connector 121 and the signal coil 122 are manufactured, and the coil member 124 and the hollow bobbin 123 are formed separately from them. The bobbin 123 can be formed by injection molding and should be formed in a hollow manner, so a pin for forming a hole is seated in the cavity of a corresponding mold, and then resin that is the raw material is injected into the cavity with the pin seated.

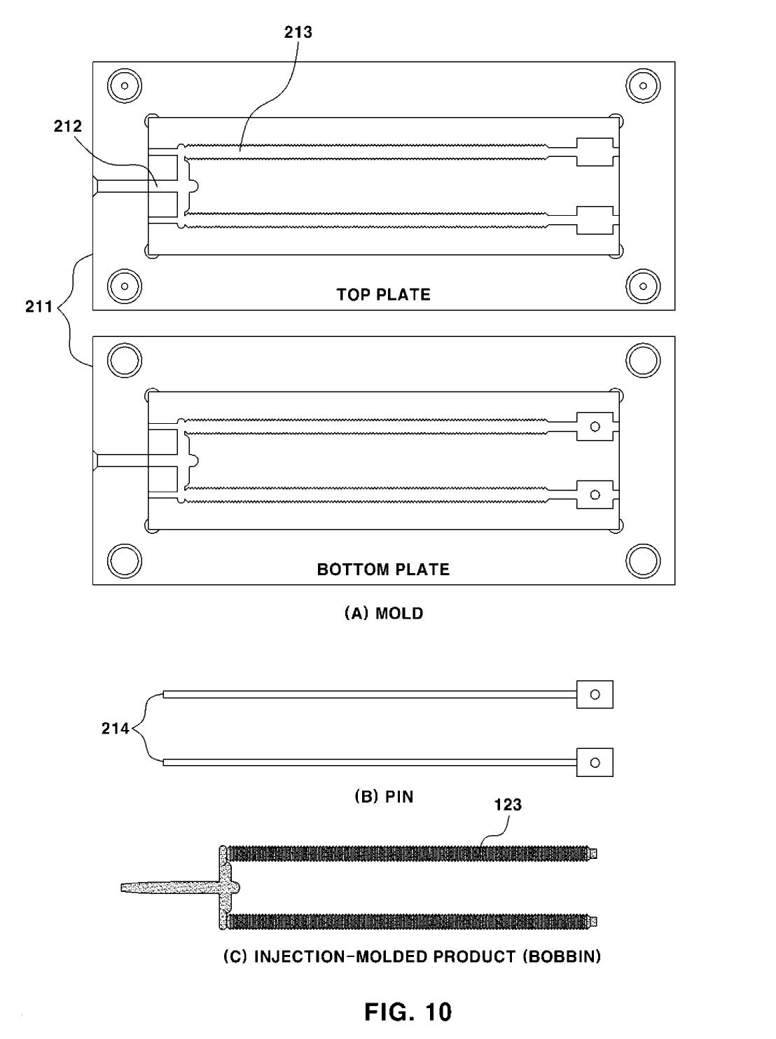

FIG. 10 is a view illustrating a mold 211 and a pin 214 for forming the bobbin 123, in which the pin 214 is seated in the cavity 213 of the mold 211, and then resin is injected through a gate 212 with the mold closed to fill around the pin 214, thereby forming the hollow bobbin 123. A thread-shaped projection for forming the spiral groove 123a around the outer side of the bobbin 123 should be formed in the inner side of the cavity 213 of the mold 211. Next, the signal coil 122 is coupled to the first coupling portion 121b of the connector 121, the coil member 124 is fitted on the formed bobbin 123, the signal coil 122 is inserted into the bobbin 123, and one end of the coil member 124 is coupled to the second coupling portion 121d of the connector 121.

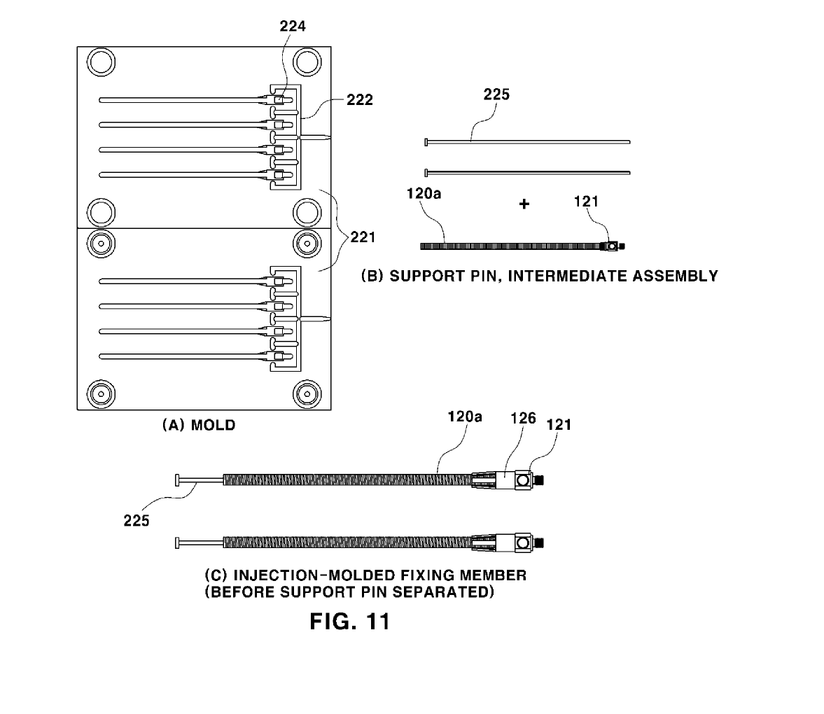

Thereafter, the fixing member 126 is injection-molded to cover the coupled portion of the connector 121 and the coil member 124. The fixing member 126 is formed after an intermediate assembly (e.g., 120a in FIGS. 9 and 11) formed by combining the connector 121 with the signal coil 122 and the coil member 124 with the bobbin 123 is seated in the corresponding mold, in which a support pin is inserted deep inside the bobbin 123 of the intermediate assembly 120a before forming to prevent the intermediate assembly 120a to move in the mold and then seated into the mold.

FIG. 11 is a view illustrating a mold 221 and support pins 225 for forming the fixing member 126. The intermediate assembly 120a with a support pin 225 inserted is seated on the inner side of the mold 221. The mold is closed resin that is the raw material is injected through a gate 222 to fill a fixing member-forming space (e.g., cavity for forming a fixing member) in the mold 221, thereby forming the fixing member 126 covering only the coupled portion between the connector 121 and the coil member 124. In this process, it is preferable to insert a portion of the connector 121 in a groove 224 on the inner side of the mold 221 in order to stably fix the support pin 225 and the intermediate assembly 120a without moving in the mold 221.

Next, when the fixing member 126 finishes being formed, the cover member 125 is injection-molded onto the outer side of the intermediate assembly 120a with the fixing member 126 formed, and the end cap 127 is assembled, thereby completing the pole 120a. The intermediate assembly 120a may be fixed without moving in the mold when forming the cover member 125, and a specific fixing assembly should be used accordingly. When the cover member 125 is formed, the other portions of the intermediate assembly 120a, except for the connecting portion 121f of the connector 121, should be spaced from the inner side of the cavity in the mold, and the intermediate assembly 120a should be fixed so as to not be moved by flow of the resin injected into the cavity. This way, the other portions of the intermediate assembly 120a except for the connecting portion 121f of the connector can be molded and covered with the resin injected into the cavity in the mold. Accordingly, the fixing assembly is configured to fix the intermediate assembly 120a without moving in the cavity in the mold and to maintain the gap so that the other portions of the intermediate assembly 120a, except for the connecting portion 121f of the connector, remains spaced from the inner side of the cavity in the mold.

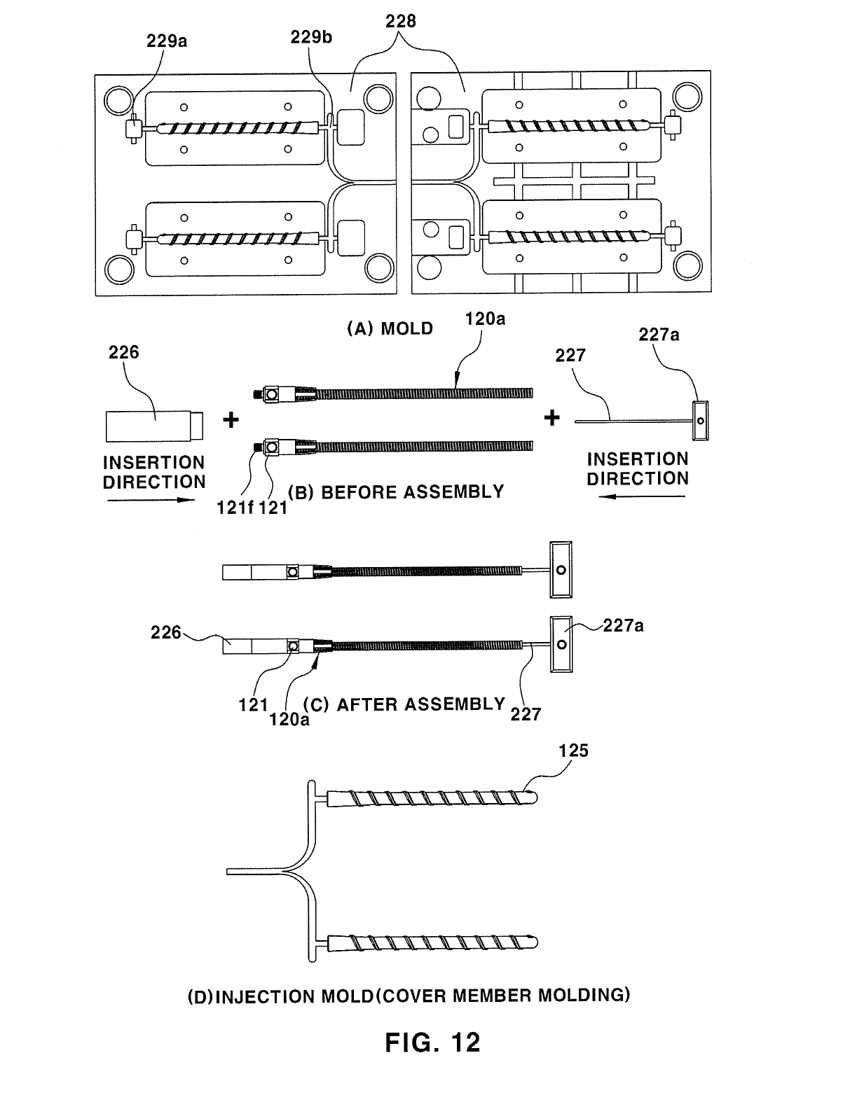

FIG. 12 is a view illustrating a mold 228 for forming the cover member 125, and FIG. 13 is a view illustrating an outer core 226 and a molding pin 227 included in the fixing assembly. The coil member (e.g., 124 in FIG. 9) should be fitted in advance in the spiral groove 123a of the bobbin 123 in the intermediate assembly 120a when the cover member 125 is formed, but the coil member 124 is not illustrated in FIG. 13.

In the manufacturing method of this embodiment, the fixing assembly may include: an outer core 226 that is fitted around the connecting portion 121f of the connector 121 of the intermediate assembly (e.g., 120a in FIG. 12) to be attached to the inner side of the mold 228; and a molding pin 227 that is inserted deep inside the bobbin 123 of the intermediate assembly 120a through the end of the bobbin 123, with a head 227a, which is inserted and fixed in a groove 229b on the inner side of the mold 228, outside the intermediate assembly 120a. The outer core 226 is fitted around one end portion of the intermediate assembly 120a, that is, the connecting portion 121f of the connector 121, and inserted and fixed in the groove 229b on the inner side of the mold 228. The outer core 226 supports one end portion of the intermediate assembly 120a, on the inner side of the mold, in order to keep the intermediate assembly 120a spaced from the inner side of the cavity.

Further, referring to FIG. 13, the molding pin 227 and the intermediate assembly (e.g., 120a in FIG. 12) have been assembled, and the figure illustrates various examples of combining the molding pin 227. As illustrated in the figure, the molding pin 227 is inserted deep inside the bobbin 123, and in forming, the head 227a of the molding pin 227 is inserted in the groove 229a on the inner side of the mold 228, whereby the head 227a in the groove 229 supports the intermediate assembly 120a. While resin is injected, the molding pin 227 should not turn and should be able to stably fix, e.g., without moving, the intermediate assembly 120a in place in the cavity. To this end, in the combination structure of the molding pin 227, it is preferable to keep the end of the molding pin 227 fixed in contact with the connector 121 or the signal coil 122 and various available examples are described hereafter.

As illustrated in (a) of FIG. 13, the molding pin 227 is inserted deep inside the bobbin 123 through the end of the bobbin 123, in which the end of the molding pin 227 can support the connector 121 or the wiring portion 122c of the signal coil 122 in contact with it, by inserting the molding pin 227 into the bobbin 123 and passing it through the helical portion 122b of the signal coil 122. In the structure with the groove 121a formed on the connector 121 and the straight end portion of the signal coil 122 fixed to the inside of the groove, eccentrically in the groove 121a, the end of the molding pin 227 can be inserted and fixed in the groove 121a (e.g., the top one in (a) of FIG. 13).

Further, in the structure with the wiring portion 122c of the signal coil 122 fixed to the connector 121 by bonding or welding (e.g., inserted in the groove 121a of the connector and then welded or welded without a hole) and thread-fastened to the outer side of the first coupling portion 121b of the connector 121, it is possible to insert the end of the molding pin 227 into the wiring portion 122c to be supported by the wiring portion 122c itself (e.g., the middle one in (a) of FIG. 13) or to bring it in contact with the first coupling portion 121b to be supported (e.g., the bottom one in (a) of FIG. 13). As in the middle one in (a) of FIG. 13, in the structure with the end of the molding pin 227 inserted in the wiring portion 122c and supported by the wiring portion 122c itself, the wiring pitch of the wiring portion 122c may be made smaller than that of the helical portion 122b or the diameter of the wiring portion 122c may be made smaller than that of the helical portion 122b, corresponding to the outer diameter of the molding pin 227. Further, as in the middle one in (a) of FIG. 13, the wiring portion 122c of the signal coil 122 can be fixed to the connector 121 by welding or bonding, and the molding pin 227 is inserted in the wiring portion 122c welded or bonded to the connector 121.

Further, as in (b) of FIG. 13, it is possible to insert the molding pin 227 into the bobbin 123 and then bring the end of the molding pin 227 in contact with the end of the signal coil 122, in which the end of the molding pin 227 and the end of the signal coil 122 support each other while in contact with each other, such that they cannot be moved when resin is injected. The signal coil 122 may be a straight pin type coil or a coil with the helical portion 122b. The means of supporting the end, as in (b) of FIG. 13, is available for both of the straight pin type coil and the signal coil 122 with the helical portion 122b.

As illustrated in (c) of FIG. 13, a hollow molding pin 227 of which a predetermined longitudinal section from the end or the entire longitudinal section can be inserted into the signal coil 122 is available. It can be seen that the end of the molding pin 227 is supported in contact with the connector 121, with the signal coil 122 inserted in the hole of the hollow molding pin 227. The signal coil 122 may be a straight pin type coil or a coil with the helical portion 122b. The means of supporting the end, as in (c) of FIG. 13, is available for both of the straight pin type coil and the signal coil 122 with the helical portion 122b.

The method of assembling the outer core 226 and the molding pin 227 was described above. The outer core 226 and the molding pin 227 are combined with the intermediate assembly 120a, and then the cover member 125 is molded by injecting resin through the gate of the mold 228 to cover the intermediate assembly 120a. When the injection molding of the cover member 125 is finished, the cover member 125 is taken out of the mold, the outer core 226 and the molding pin 227 are removed, and the end cap 127 is inserted into the hole 125a of the cover member 125 with the molding pin 227 removed, thereby completing the pole 120.

Further, the multiple band antenna 100 (as shown in FIG. 3) is achieved by combining the completed pole 120 with the base 110, in which the pole 120 is fixed to the base 110 by coupling the connecting portion 121f of the connector 121 to the connector 121 of the base 110.

Although embodiments of the present disclosure were described in detail above, the scope of the present disclosure is not limited thereto, and various changes and modifications from the spirit of the present invention defined in the following claims by those skilled in the art are also included in the scope of the present disclosure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A multiple band antenna for a vehicle comprising an elongated pole that is coupled to a base, wherein the pole includes:
a connector having a connecting portion connected to a terminal of the base;
a signal coil having one end portion connected to the connector and having a spirally wound helical portion;
a bobbin fitted around the signal coil such that the signal coil is inserted therein;
a coil member formed in the shape of a spirally wound coil and fitted around the bobbin, with one end portion connected to the connector; and
a cover member covering the bobbin and the coil member.

2. The multiple band antenna of claim 1, further comprising:
a fixing member covering a coupled portion at which the connector and the coil member are coupled together and fixing the coupled portion of the connector and the coil member.

3. The multiple band antenna of claim 1, wherein the signal coil has one helical portion or a plurality of helical portions that is longitudinally arranged.

4. The multiple band antenna of claim 1, wherein the signal coil has a combination of straight portions and helical portions that are longitudinally arranged.

5. The multiple band antenna of claim 3, wherein the signal coil has the plurality of helical portions, and the helical portions all have the same wiring pitch.

6. The multiple band antenna of claim 3, wherein the signal coil has the plurality of helical portions, and only some of the helical portions have the same wiring pitch or all of the helical portions have a different wiring pitch.

7. The multiple band antenna of claim 1, wherein the signal coil and the connector are connected by inserting one end portion of the signal coil into a groove formed in the connector and welding or bonding the one end portion of the signal coil, or by inserting the one end portion of the signal coil into the groove of the connector and then welding or bonding the one end portion to an inner side of the groove.

8. The multiple band antenna of claim 1, wherein the signal coil and the connector are connected by thread-fastening a wiring portion, which is formed by spirally wiring one end portion of the signal coil, to a spiral groove formed around an outer side of a first coupling portion of the connector.

9. The multiple band antenna of claim 8, wherein the wiring portion is welded or bonded to the outer side of the connector.

10. The multiple band antenna of claim 1, wherein a spiral groove is formed around an outer side of the bobbin, and the coil member is thread-fastened in the spiral groove on the bobbin.

11. The multiple band antenna of claim 1, wherein a spiral groove is formed around an outer side of a second coupling portion of the connector, and the coil member is thread-fastened in the spiral groove on the second coupling portion.

12. The multiple band antenna of claim 1, wherein the coil member has a different wiring pitch for each of coil member sections that are longitudinally defined.

13. The multiple band antenna of claim 1, wherein an end cap is inserted deep inside the bobbin through a hole at an end of the cover member, with one end portion of the end cap closing the hole at the end of the cover member.

14. The multiple band antenna of claim 1, wherein the cover member also covers the signal coil and the connector except for the connecting portion of the connector.

15. A method of manufacturing a multiple band antenna for a vehicle which includes an elongated pole that is coupled to a base, the method for manufacturing the pole, comprising:
manufacturing a signal coil and a connector with a connecting portion connected to a terminal of the base;
manufacturing a bobbin and a coil member formed in a shape of a spirally wound coil;
connecting one end portion of the signal coil to the connector;
fitting the coil member around the bobbin;
forming an intermediate assembly by fitting the bobbin around the signal coil such that the signal coil is inserted therein and by connecting one end portion of the coil member to the connector;
fixing the intermediate assembly in a mold; and
injection-molding a cover member to cover the coil member and the bobbin.

16. The method of claim 15, further comprising:
forming a fixing member that covers a coupled portion at which the connector and the coil member are coupled together and fixes the coupled portion of the connector and the coil member, before the injection-molding of the cover member.

17. The method of claim 16, wherein the fixing member is formed by injection-molding, and in the injection-molding of the fixing member, the fixing member is formed by i) inserting a support pin deep inside the bobbin of the intermediate assembly, ii) inserting and fixing a head of the support pin and the connector into grooves on an inner side of a mold, and iii) injecting resin into the mold.

18. The method of claim 15, wherein the signal coil is formed to have a spirally wound helical portion.

19. The method of claim 15, wherein a fixing assembly that fixes portions of the intermediate assembly except for the connecting portion of the connector is formed at a predetermined distance from an inner side of a cavity in a mold, in the forming of the cover member, and
the fixing assembly includes:
an outer core fitted around the connecting portion of the connector and attached to the inner side of the mold; and
a molding pin inserted deep inside the bobbin of the intermediate assembly through an end of the bobbin and fixed with a head of the support pin, which is exposed to an outside of the intermediate assembly and inserted in a groove on the inner side of the mold.

20. The method of claim 19, wherein an end of the molding pin which is inserted in the bobbin keeps fixed while in contact with the connector or the signal coil.

21. The method of claim 20, wherein the signal coil is formed to have a spirally wound helical portion, and the molding pin is inserted through the helical portion of the signal coil such that the end of the molding pin is brought in contact with the connector.

22. The method of claim 21, wherein a straight end portion of the signal coil is fixed eccentrically to an inner side of a groove of the connector, and the end of the molding pin is inserted into the groove of the connector.

23. The method of claim 21, wherein a wiring portion is formed by wiring an end portion of the signal coil that is coupled to the connector, and inserting the end of the molding pin into the wiring portion to be supported by the wiring portion itself or in contact with the connector.

24. The method of claim 20, wherein an end of the molding pin and an end of the signal coil are brought in contact with each other so that the molding pin and the signal coil are supported by each other.

25. The method of claim 20, wherein the signal coil is inserted into a hole of a hollow molding pin inserted in the bobbin, the hollow molding pin having a predetermined longitudinal section.

26. The method of claim 15, wherein an end cap is inserted deep inside the bobbin through a hole at an end of the cover member, the end cap closing the hole at the end of the cover member.
